(19) United States
(12) Patent Application Publication
(10) Pub. No.: US 2025/0238338 A1
(43) Pub. Date: Jul. 24, 2025

(54) Automatic Host Triaging And Repair Using Structured Logging

(71) Applicant: Oracle International Corporation, Redwood Shores, CA (US)

(72) Inventors: Ashok Prakash, Renton, WA (US); Sunil Vikram Soman, Seattle, WA (US)

(73) Assignee: Oracle International Corporation, Redwood Shores, CA (US)

(21) Appl. No.: 18/416,732

(22) Filed: Jan. 18, 2024

(51) Int. Cl. G06F 11/267; G06F 11/277

(52) U.S. Cl. CPC G06F 11/267; G06F 11/277

(57) ABSTRACT

Techniques for diagnosing and repairing provisioned physical machines are disclosed. The system identifies a provisioned physical machine for diagnosing an issue. The system executes respective tests on a subset of components comprising the physical machine to generate a target component log. The system obtains a set of base component logs generated by executing the test on a set of base physical machines and evaluates the target component log based on the set of base component logs to identify an anomalous portion of the target component log. The system selects a remediation operation based on the anomalous portion of the target component log and executes the remediation operation for the provisioned physical machine for addressing the issue.

### TECHNICAL FIELD

The present disclosure relates to automatically diagnosing and repairing physical host machines. In particular, the present disclosure relates to automatically testing the computing components that make up a physical machine to identify the computing component that is malfunctioning, identify a repair procedure, and then repair the identified computing component.

### BACKGROUND

A customer of a cloud service provider may use physical computing resources, referred to as a baremetal host or physical machine, within the cloud service provider's premises. A provisioned physical machine can develop a performance issue, including issues related to hardware problems. A hardware issue that arises from one particular computing component within the physical machine may cause other computing components to malfunction. Diagnosing and repairing the actual problem can be challenging to do efficiently while minimizing downtime for the customer.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIG. 7 illustrates an example set of operations for diagnosing and repairing a physical machine in accordance with one or more embodiments;

FIG. 8 illustrates an example of a platform definition in accordance with one or more embodiments; and

FIG. 9 illustrates a machine learning process according to one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. HOST HEALTH MONITORING AND REPAIR ARCHITECTURE
5. DIAGNOSING AND REPAIRING PHYSICAL MACHINES
6. EXAMPLE EMBODIMENT
7. MACHINE LEARNING
8. PRACTICAL APPLICATIONS, ADVANTAGES, AND IMPROVEMENTS
9. MISCELLANEOUS; EXTENSIONS

### 1. GENERAL OVERVIEW

One or more embodiments diagnose the cause(s) of malfunction in a provisioned physical machine by executing stateless tests on one or more of the computing components that make up the physical machine and comparing the test outputs to outputs from testing functional physical machines.

The system identifies a provisioned physical machine having an issue that needs diagnosis. The system executes a test on a subset of the components on the physical machine to generate a target component log. The target component log is evaluated against a set of base component logs that were generated by executing the test on a set of base physical machines. When the evaluation of the target component log identifies an anomaly, the system selects a remediation operation based on the identified anomaly and execute the remediation operation to address the issue.

One or more embodiments described in this Specification and/or recited in the claims may not be included in this General Overview section.

### 2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling Operating System (OS), middleware, and/or application deployment e.g., on self-service virtual machines that can be spun up on demand.

In some examples, IaaS provisioning may refer to acquiring computers or virtual hosts for use and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. In some instances, the provisioning can be done manually, a provisioning tool may be utilized to provision the resources, and/or deployment tools may be utilized to deploy the code once the infrastructure is provisioned.

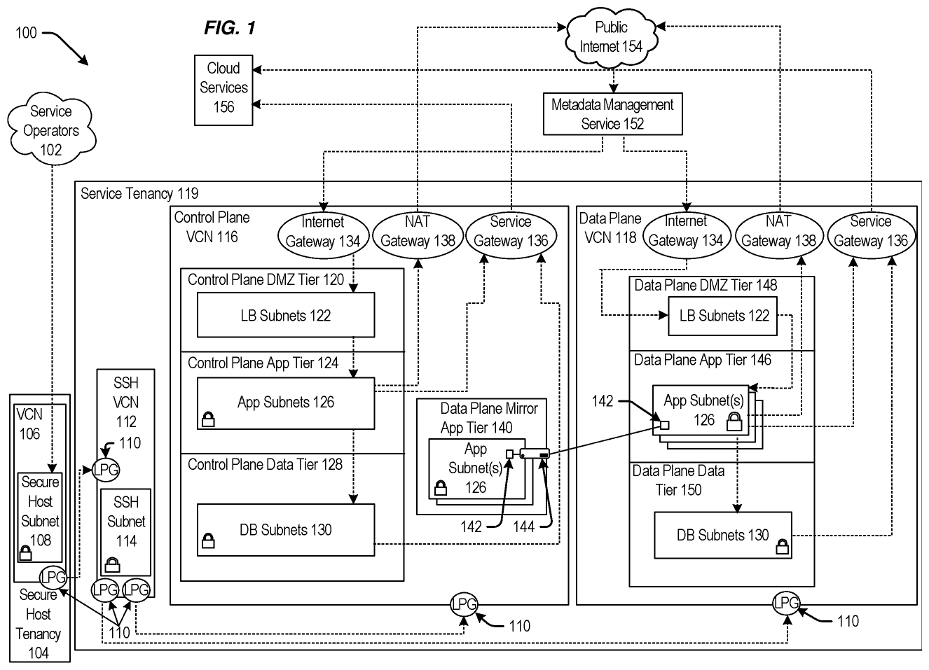

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices that may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124. The LB subnet(s) 122 may further be communicatively coupled to an Internet gateway 134 that can be contained in the control plane VCN 116. The app subnet(s) 126 can be communicatively coupled to the DB subnet(s) 130 contained in the control plane data tier 128, a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The service gateway 136 can make API calls to cloud services 156, and cloud services 156 can send requested data to the service gateway 136.

In some examples, the secure host tenancy 104 can be directly connected to the service tenancy 119 that may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118. The data plane mirror app tier 140 of the control plane VCN 116 can communicate with the data plane app tier 146 of the data plane VCN 118 via VNICs 142. VNICs 142 can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configurations of resources contained in the data plane VCN 118.

In some embodiments, the control plane VCN 116 and the data plane VCN 118 can be contained in the service tenancy 119. The user, or the customer, of the system may be restricted from owning or operating either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users' or other customers' resources. Also, this embodiment may allow users or customers of the system to store databases privately without needing to rely on public Internet 154 that may not have a desired level of threat prevention for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119 that may be isolated from public Internet 154.

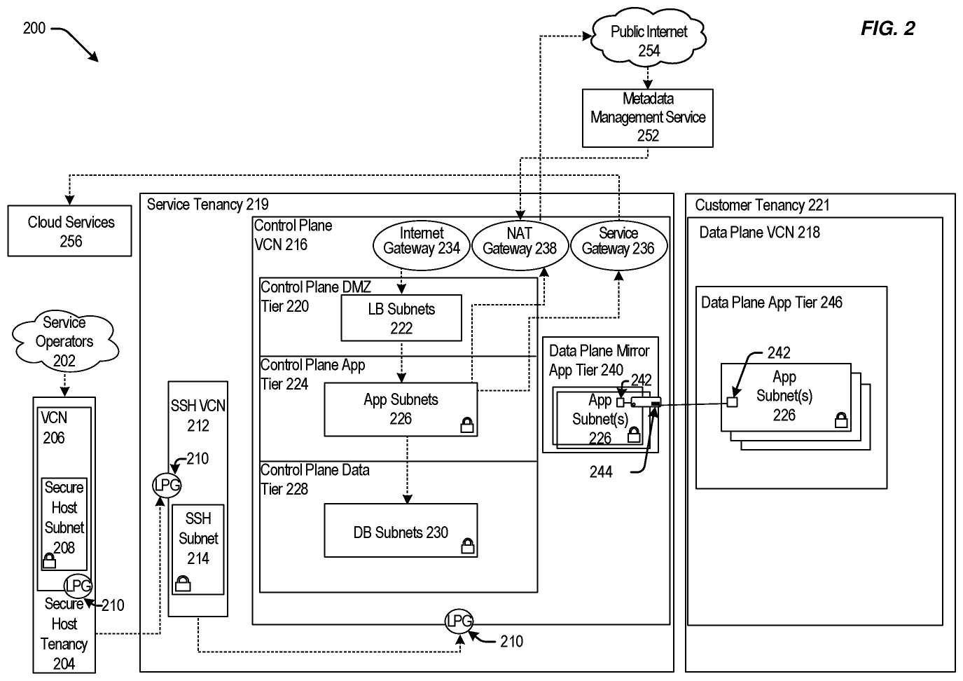

FIG. 2 is a block diagram illustrating another example pattern of an IaaS architecture 200, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1). The Internet gateway 234 can be contained in the control plane VCN 216. Additionally, the app subnet(s) 226 can be communicatively coupled to the DB subnet(s) 230 contained in the control plane data tier 228, a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216, contained in the service tenancy 219, and the data plane VCN 218, contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in Region 1, and cloud service Deployment 1 may be located in Region 1 and in Region 2. If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

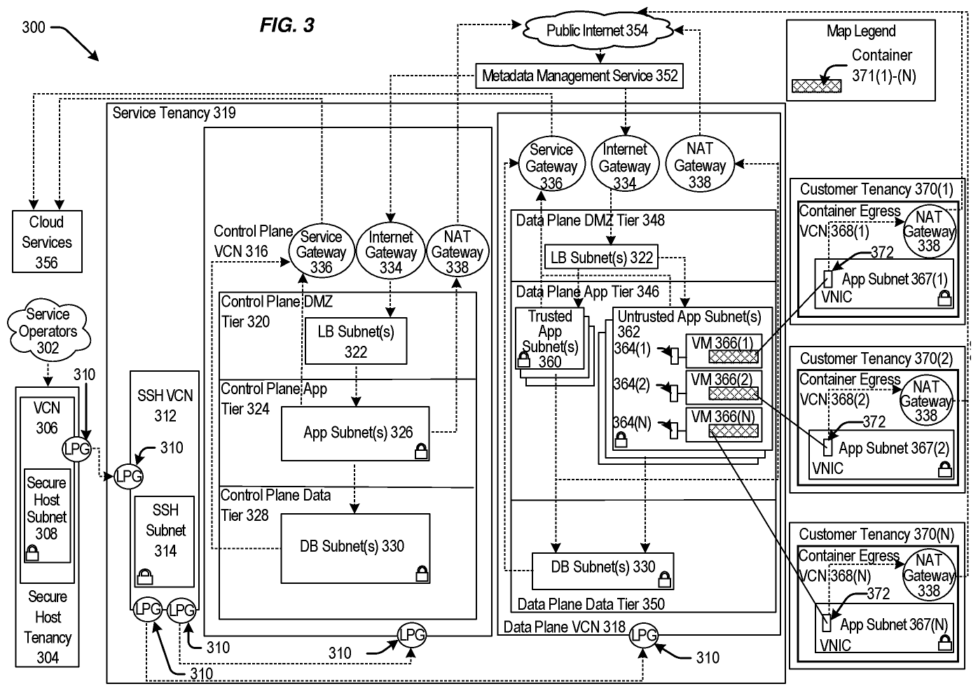

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316. Additionally, the app subnet(s) 326 can be communicatively coupled to the DB subnet(s) 330 contained in the control plane data tier 328, to a service gateway 336 (e.g., the service gateway of FIG. 1), and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code, where the containers 381(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

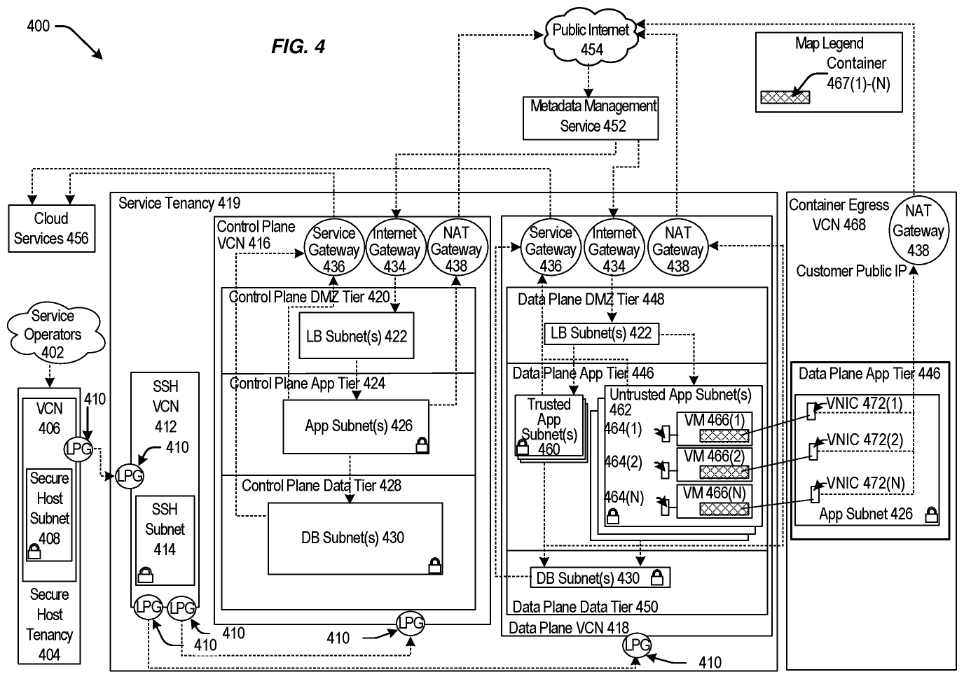

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1). The SSH VCN 412 can be communicatively coupled to a control plane VCN 416 (e.g., the control plane VCN 116 of FIG. 1) via an LPG 410 contained in the control plane VCN 416. The SSH VCN 412 can be communicatively coupled to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424. The LB subnet(s) 422 can be communicatively coupled to an Internet gateway 434 (e.g., the Internet gateway 134 of FIG. 1) that can be contained in the control plane VCN 416. The app subnet(s) 426 can be communicatively coupled to the DB subnet(s) 430 contained in the control plane data tier 428, a service gateway 436 (e.g., the service gateway of FIG. 1), and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3. The pattern illustrated by the architecture of block diagram 400 of FIG. 4 may be implemented for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are non-limiting examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use the same network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset stored by the computer network is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates the tenants that have authorization to access an application. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. COMPUTER SYSTEM

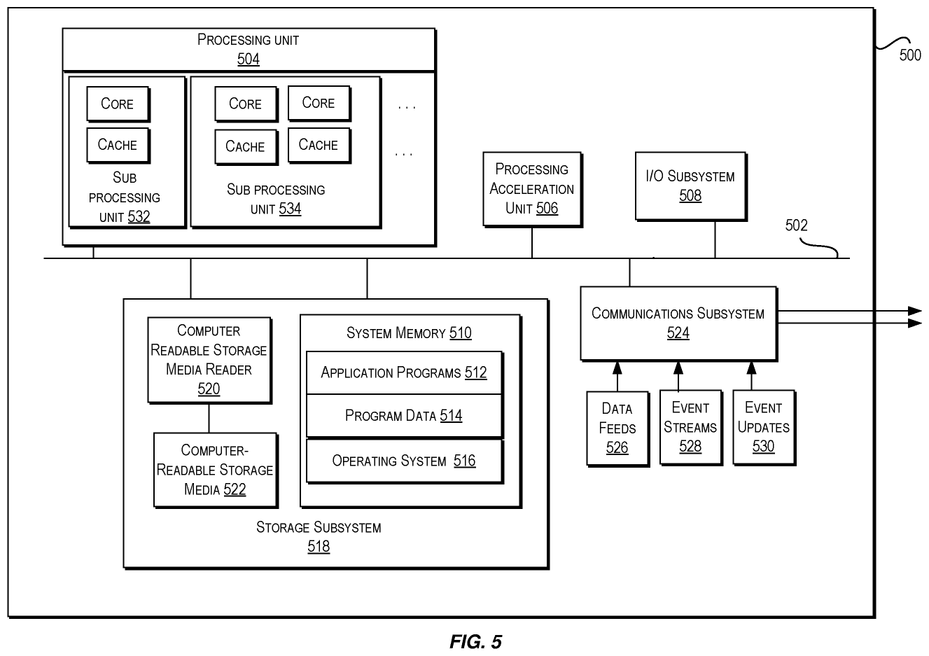

FIG. 5 illustrates an example computer system 500, where various embodiments may be implemented. The system 500 may be used to implement any of the computer systems described above. As shown in FIG. 5, computer system 500 includes a processing unit 504 that communicates with several peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The PCI bus can be implemented as a Mezzanine bus manufactured to the IEEE P1386.1 standard.

Processing unit 504 that can be implemented as one or more integrated circuits (e.g., a conventional microprocessor or microcontroller) controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some of the program code to be executed can be resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator) through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 500 may comprise a storage subsystem 518 that provides a tangible, non-transitory, computer-readable storage medium for storing software and data constructs that provide the functionality of the embodiments described in this disclosure. The software can include programs, code modules, instructions, scripts, etc., that when executed by one or more cores or processors of processing unit 504, provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations, where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams that may include event streams 528 of real-time events and/or event updates 530 that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended only as a specific example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. HOST HEALTH MONITORING AND REPAIR ARCHITECTURE

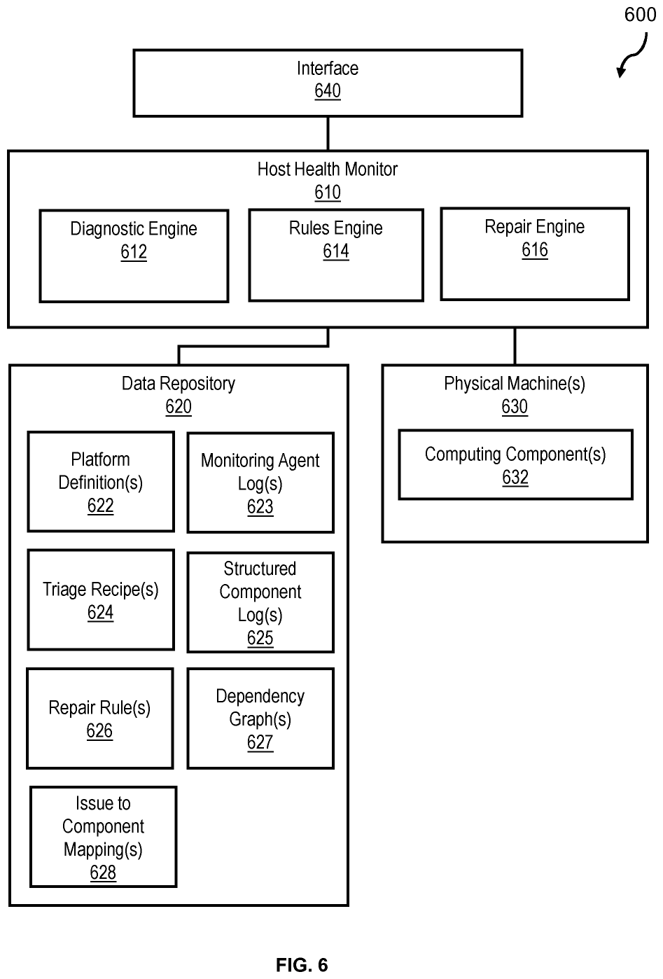

FIG. 6 illustrates a system 600 in accordance with one or more embodiments. As illustrated in FIG. 6, system 600 includes a host health monitor 610, a data repository 620, one or more physical machines 630, and an interface 640. The host health monitor 610 may include one or more functional components, such as a diagnostic engine 612, a rules engine 614, and a repair engine 616. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

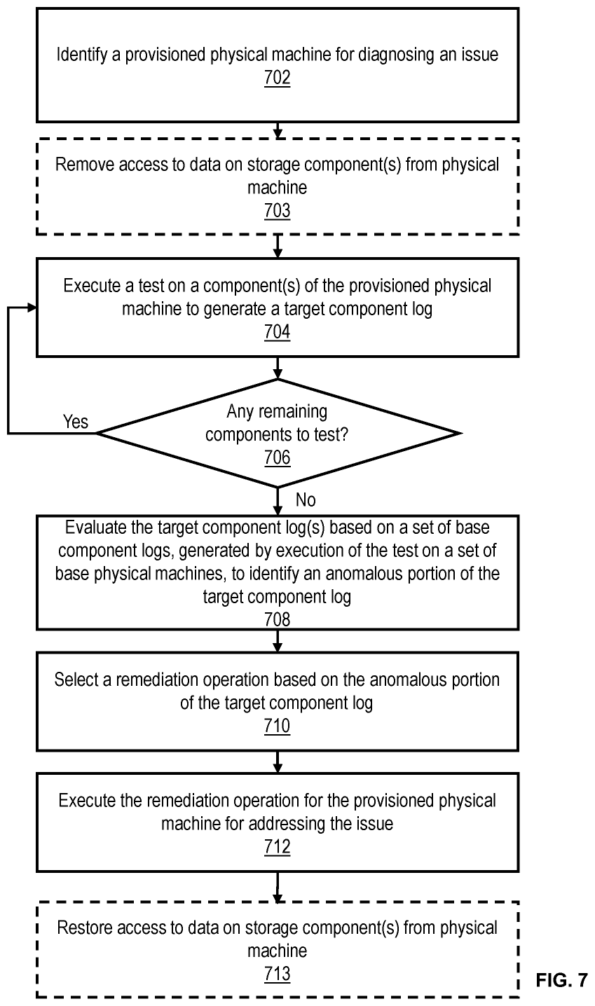

In one or more embodiments, host health monitor 610 refers to hardware and/or software configured to perform operations described herein for diagnosing and repairing computing platform configurations, including physical machines. Examples of operations for diagnosing and repairing physical machines are described below with reference to FIG. 7.

A provisioned physical machine 630 is a collection of physical computing components operating as a single computer and in use by a customer. The physical machine may include one or more bare-metal servers. The physical machine may be housed on the premises of a cloud service provider. The physical machine may be accessible to a customer of the cloud service provider. The physical machine may be inaccessible to any other customers of the cloud service provider. The cloud service provider may have limited access to one or more components of the physical machine, for example, for monitoring and maintenance purposes.

The physical computing components 632 for a given physical machine 630 can include, for example, a central processing unit (CPU), a graphics processing unit (GPU), a root of trust device (RoT), a network interface card (NIC), volatile memory, non-volatile memory, a storage device, buses, switches, fans, and so forth.

The host health monitor 610 may ingest monitoring agent logs 623 and determine that a hardware component of a physical machine is malfunctioning and requires repair. A monitoring agent log 623 may include information about the operations of a computing component. The information may include an indication of an issue with a physical machine, such as a boot failure, a GPU dropped error, reduced performance, a corrupted drive, or a system failure.

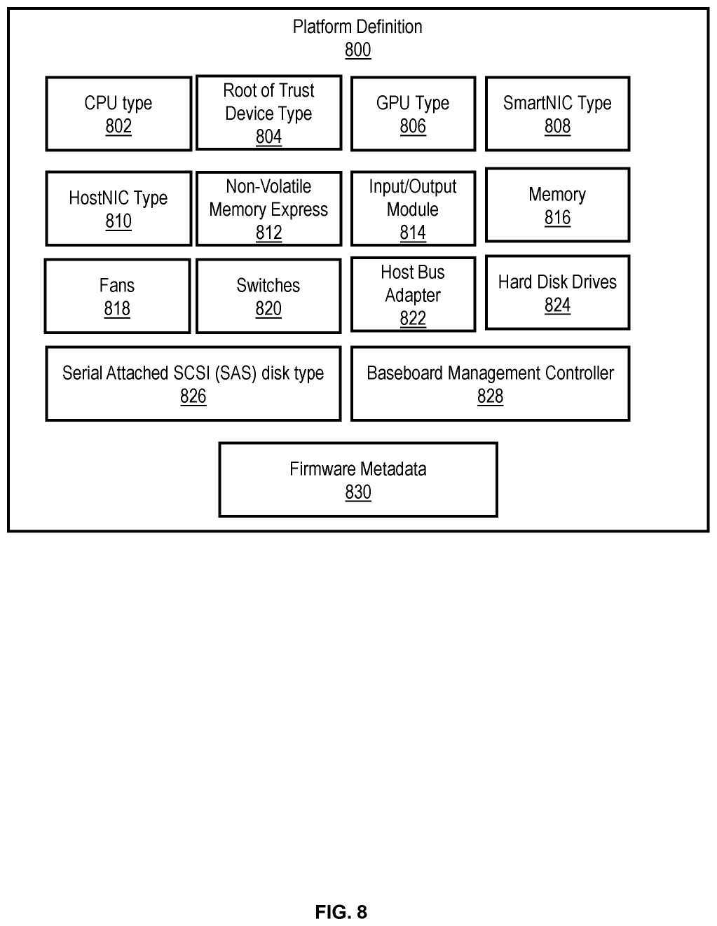

A platform definition 622 may identify and define each computing component 632 included on a physical machine 630 that is to be diagnosed and repaired. For a given computing component in the physical system 630, the platform definition 622 may include, for example, an identification number for the computing component, a manufacturer, a model or version number, a firmware version, and/or a driver version. An example of a platform definition is described with respect to FIG. 8.

The diagnostic engine 612 may execute one or more triage recipes 624 on the physical machine. A computing component may have a corresponding triage recipe. Different computing components may have different triage recipes. A triage recipe includes instructions for one or more tests of the operations of the computing component. For example, a triage recipe may include tests for whether or not a computing component can power on, establish a connection to another computing component, read from a storage component, or write data to a storage component.

When executed, the triage recipe may generate a structured component log 625. The structured component log 625 may include a field for each test conducted from the triage recipe, a result of the test, a command executed during a test, an output or status of a test operation, a time stamp of an operation, an error code, or any other information generated in the execution of the test. The structured component log 625 may be a text-based file whose fields are delimited by text characters. Alternatively, the structured component log 625 may be a JSON object, a set of database records, a table, or any other data structure.

The structured component logs 625 may also include base component logs. Base component logs may include the output of executing triage recipes on the computing components of one or more base physical machines. In one or more embodiments, the base physical machines include a plurality of provisioned physical machines of a variety of configurations that are operating as expected according to the respective hardware and software in a given configuration. The base physical machines may include provisioned physical machines sampled from the set of provisioned machines operating for a variety of customers. The base physical machines may include a set of provisioned physical machines that are reserved by the cloud service provider for testing purposes. The base component logs may be used to compare against subsequent structured component logs generated while diagnosing a malfunctioning physical machine.

The rules engine 614 may process the structured component logs 625 to determine the one or more computing components that are malfunctioning and what one or more issues is causing the malfunction. For example, if a physical machine is not booting, the issue may be caused by several different components. The rules engine 614, after processing the structured component logs, can determine if the issue is caused by an incorrect BIOS, a failing SSD or memory, a failing NIC, a failing NIC cable, or a combination of failures.

The rules engine 614 may also output an indication of a repair needed to address the issue. The rules engine 614 may output a selection of a repair rule 626. The repair rule 626 may include commands or instructions to further diagnose the issue based on an identified anomalous portion of the structured component log and output a specific action to address the issue. In some instances, a repair rule associated with a failed triage recipe operation may include additional diagnostic steps for the system to take based on the anomalous portion of the structured component log. For example, if a power-on triage test for a NIC card fails, the repair rule may include steps that cause the system to check the status in the structured component log of tests on related components such as a cable check test for a NIC card cable.

When the specific action involves modifying software, the repair rule may include instructions or operations that can be executed to update or replace firmware, drivers, or other software resident on the physical machine. When the specific action involves modifying hardware, the repair rule 626 may output an indication of the hardware component that needs to be replaced.

The repair engine 616 may execute the selected repair rule and execute repairs that do not involve a physical replacement of a computing component. For example, the repair engine 616 may update firmware on a computing component. For repairs that involve the replacement of a computing component, the repair engine 616 may generate an alert or other indication of the specific computing component that should be replaced and may indicate the specifications of the replacement computing component.

Dependency graphs 627 may include relationships between computing components on a physical machine. A dependency graph may include a node for each computing component in the platform definition for a provisioned physical machine. When one computing component depends on another computing component, the dependency graph may include a directed edge between the nodes corresponding to the two computing components. A dependency of a first computing component on a second computing component may mean that the first computing component receives data from the second computing component. Another dependency may mean that the first computing component is required to wait for the second computing component to be powered on and operational before the first computing component can be powered on and operational. Other dependency relationships may exist between computing components. In one or more embodiments, the diagnostic engine 612 may use the dependency graph for a physical machine to determine the order to execute the triage recipes for the physical machine computing components.

The issue to component mappings 628 may include a relationship between a physical machine issue and the computing component or components that may be the cause of the issue. For example, a mapping 628 may include a mapping of the issue of a physical machine failing to boot to the BIOS, the SSD, the NIC, and the NIC cable. In one or more embodiments, the triage engine 612 may use a mapping 628 to select a subset of the computing components in a physical machine for testing rather than testing every computing component 632.

In one or more embodiments, a data repository 620 is any type of storage unit and/or device (e.g., a file system, database, collection of tables, or any other storage mechanism) for storing data. Further, a data repository 620 may include multiple different storage units and/or devices. The multiple different storage units and/or devices may or may not be of the same type or located at the same physical site. Further, a data repository 620 may be implemented or executed on the same computing system as the host health monitor 610. Additionally, or alternatively, a data repository 620 may be implemented or executed on a computing system separate from the host health monitor 610. The data repository 620 may be communicatively coupled to the host health monitor 610 via a direct connection or via a network.

Information describing platform definitions 622, monitoring agent logs 623, triage recipes 624, structured component logs 625, repair rules 626, dependency graphs 627, and issue to component mappings 628 may be implemented across any of components within the system 600. However, this information is illustrated within the data repository 620 for purposes of clarity and explanation.

In an embodiment, the host health monitor 610 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 640 refers to hardware and/or software configured to facilitate communications between a user and the host health monitor 610. Interface 640 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 640 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 640 is specified in one or more other languages, such as Java, C, or C++.

### 5. DIAGNOSING AND REPAIRING PHYSICAL MACHINES

FIG. 7 illustrates an example set of operations for automatically diagnosing and repairing physical machines in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system identifies a provisioned physical machine for diagnosing an issue (Operation 702). The system may receive a request to repair a provisioned physical machine from the customer or tenant using the physical machine. For example, the system may provide an application program interface (API) through which the customer can send a repair request. The repair request may include a potential issue associated with the malfunction, such as “boot failure” or “disk failure”. Alternatively, or additionally, the system may read the monitoring agent logs for provisioned physical machines for indications that a physical machine has an issue that is causing the physical machine to malfunction. While a monitoring agent log may indicate the issue affecting the physical machine, the monitoring agent log will generally not include the reason for the issue.

The system may optionally remove access to data on one or more storage components of the physical machine (Operation 703). The system may disable read and write access to a disk drive or other storage medium, for example, by turning off a PCIE slot for a drive. This operation may protect the data on the storage component from being altered during subsequent triage testing.

The system may execute a test on a component of the provisioned physical machine to generate a target structured component log (Operation 704). The system may retrieve the platform definition for the physical system to determine what components are included in the physical machine. The system may retrieve the triage recipe for at least one of the computing components.

In one or more embodiments, testing the computing components of the physical machine is a stateless process. The system may select computing components for testing regardless of the potential issue. In some instances, the system may test every computing component in the physical machine. In other instances, the system may test a subset of the computing components that are mapped to the potential issue. For example, if a repair request and/or a monitoring agent log indicates an issue with a specific component, such as a drive failure, the system may select the drive for testing as well as a related controller, a host bus adapter, and other components associated with a data path from the drive. When a triage recipe for a computing component includes multiple tests for multiple operations for the computing component, the system may execute the entire triage recipe rather than selecting specific tests from within the triage recipe.

In one or more embodiments, the system may use the dependency graph to determine the computing components that need to be tested as well as an order of testing them. The system executes the triage recipe by performing the operations included in the triage recipe. As the system executes the triage recipe, the system writes the results of the operations to a target structured component log for the physical machine. The system may also write additional information to the target structured component log, such as timestamp information related to when an operation begins and/or ends, version and/or configuration information of software, firmware, or other components encountered during the operation, and a sequence of events that occurs during the operation.

The system may determine if there are any remaining untested components in the physical machine to test (Operation 706). When there are untested components remaining, the system may select a next computing component to test and returns to operation 704. The system may select the next untested component in the platform definition or a computing component that is dependent on the computing component that was just tested. In one or more embodiments, if the issue affecting the physical machine is mapped to a subset of one or more computing components of the physical machine, the system may determine if there are any untested computing components left in the subset of components.

When all the computing components to be tested have been tested, the system may evaluate the target component log based on a set of base component logs to identify an anomalous portion of the target component log (Operation 708). The system may compare the target component log to the component logs in the set of base component logs. When a portion of the target component log corresponding to a computing component does not match the base component logs for the same type of computing component, the system may identify the non-matching portion as an anomalous portion.

In one or more embodiments, the system may identify an anomalous portion of the target component log based on an indication that a particular triage recipe operation failed. The system may, for example, identify the failed operation and may output the computing component that failed.

In one or more embodiments, the system may provide the structured component log to a diagnostic machine learning model trained on sets of base component logs and structured component logs that are labeled according to the outcome of a triage recipe on a given component. The diagnostic machine learning model may output a label or other indication of one or more anomalous portions within the structured component logs. The diagnostic machine learning model may identify any triage recipe operations that failed.

In some instances, the structured component log may not indicate any failed tests even though the customer requesting the repair has reported an issue. The diagnostic machine learning model may identify other anomalous portions in the structured component log. For example, the diagnostic machine learning model may identify, based on time stamps in the structured component log, that an elapsed time between two operations exceeds an expected elapsed time. In another example, the diagnostic machine learning model may identify a firmware version for a component that differs from an expected firmware version. In another example, the diagnostic machine learning model may identify a sequence of operations in the structured component log that differs from an expected sequence.

The system may select a remediation operation based on the anomalous portion of the target component log (Operation 710). The system may select a repair rule based on the computing component associated with the anomalous portion of the target component log and what the anomalous portion indicates. For example, if the target component log indicates a failed connection test for a NIC card, the system may select a repair rule for the NIC card failed connection test. The repair rule may include additional parameters for the system to check, such as whether or not a cable check for a NIC card cable failed. The system may evaluate the additional parameters and select a remediation operation based on the additional evaluation.

In one or more embodiments, the system may provide the anomalous portion(s) of the target structured component log to a repair machine learning model trained on sets of anomalous portions of structured component logs labeled with one or more remediation operations associated with repairing an issue corresponding to the anomalous portion. The repair machine learning model may output one or more remediation operations that identify what actions to take to repair the issue affecting the physical machine.

The system may execute the remediation operation for the provisioned physical machine to address the issue (Operation 712). When the repair rule includes a remediation operation that does not involve a physical replacement or repair of the affected computing component, the system may execute a software-based remediation, such as updating firmware, drivers, or other software instructions included in the physical machine. For remediation operations that involve hardware repair or replacement, the system may output a notification that indicates the computing component that is affected and what physical steps to take to resolve the issue. Physical repair steps may include reseating a computing component within the physical machine, replacing the computing component with a different copy of the same computing component, replacing a cable, and checking a power cycle for a computing component. Once the physical repair has been performed by a technician, a remediation operation may further include operations to update firmware, drivers, or other software operations to restore functionality of the physical machine.

The system may optionally restore access to data on the storage on the one or more storage components of the physical machine (Operation 713). The system may re-enable write operations for the one or more storage components, for example, by turning on the PCIE slot for the storage.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 8 illustrates an example of a platform definition 800 of a physical system. The platform definition 800 may be a list, a vector, an array, or another set of elements that define the computing components of a particular physical system. Each element in a platform definition may include a part number for the corresponding computing component, where each type of computing component has a unique part number.

For example, the platform definition may include one or more of a central processing unit (CPU) type 802, a Root of Trust (ROT) device type 804, and a graphics processing unit (GPU) type 806. Each of the elements 802, 804, 806, and 808 may specify the architecture of the respective computing component on the physical machine, e.g., a manufacturer, a model, and/or a version number. The platform definition 800 may include a Smart Network Interface Controller (NIC) type 808 and/or a Host NIC type 810.

The platform definition may include a non-volatile memory express (NVME) type 812 that specifies a manufacturer, the size, and the number of NVMEs on the physical machine. The platform definition may include an input/output module (IOM) type 814 that specifies the manufacturer of IOM device that connects the storage devices on the physical machine. The platform definition may include a memory type 816 that specifies an amount and type of memory on the physical machine. The platform definition may include a fan type 818 and a switches type 820 that specifies, respectively, a number of fans on the system for controlling the temperature and a number and type of switches that connect the computing components to a network infrastructure on the physical machine.

The platform definition may include a host bus adapter (HBA) type 822 and a hard disk drives (HDD) element 824. The HBA type 822 may specify a manufacturer and/or type of HBA used to connect a large number of disk drives. The HDD element may include the number of disk drives on the physical machine, a capacity for each disk drive, and/or a manufacturer for each disk drive.

The platform definition may include a serial attached SCSI (SAS) disk type 826 that specifies a disk manufacturer, the number of disks, and their respective sizes. The platform definition may include a baseboard management controller (BMC) type 828 that specifies the type of BMC device.

The platform definition may also include firmware metadata 830. The firmware metadata 830 may include manufacturer-release files for one or more of the computing components included in the platform definition.

The platform definition may include fewer elements than those illustrated. The platform definition may include multiple elements for the same type of computing component. For example, if the corresponding physical machine includes multiple hard drives, the platform definition may include a separate element for each individual drive. Alternatively, if the corresponding physical machine includes multiple instances of the same computing component, e.g., multiple CPUs, the platform definition may include one element for the computing component with an indication in the element of the number of that computing component.

In one or more embodiments, two or more computing components may be grouped together as a collection of sub-components. For example, a computing component that comprises a collection of storage disks, referred to as “just a bunch of disks” or JBOD, may include, as sub-components, the disks, a host bus adapter (HBA), and an input/output module (IOM). The platform definition may, accordingly, include a separate platform definition for the JBOD that may include the sub-components, for example, nested within the platform definition for the JBOD.

### 7. MACHINE LEARNING

A machine learning algorithm is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm that in turn updates the target model f.

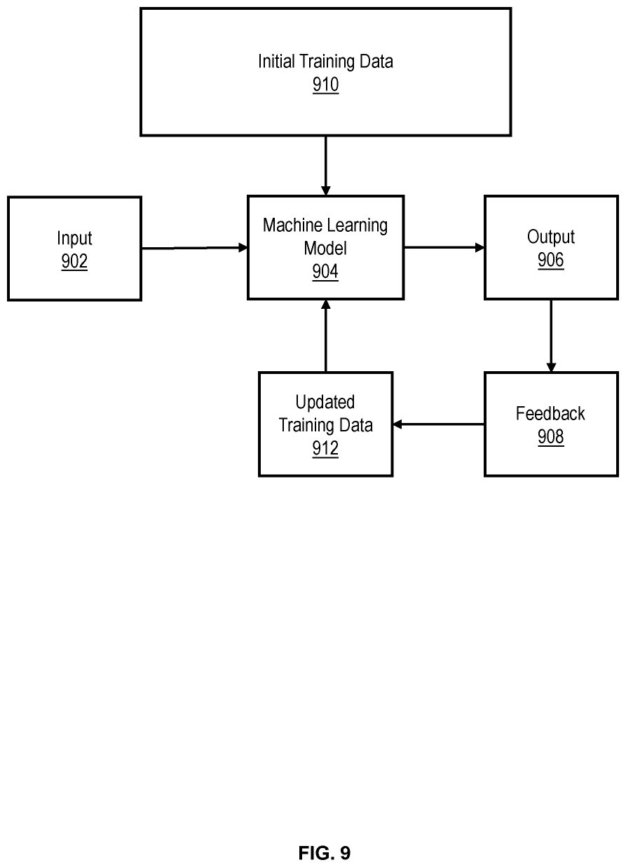

FIG. 9 illustrates a machine learning process according to one or more embodiments. A machine learning model 904 may be iteratively trained on initial training data 910 to map a set of input variables to an output variable. For a diagnostic machine learning model, the initial training data 910 may include one or more sets of base component logs and structured component logs labeled according to the outcome of a triage recipe on a given component. For a repair machine learning model, the initial training data 910 may include one or more sets of anomalous portions of structured component logs labeled with one or more remediation operations associated with repairing an issue corresponding to the anomalous portion. Additionally, or alternatively, the initial training data 910 may include sets of parameter values for computing components for functional physical machines, sets of parameter values for computing components for dysfunctional physical machines, and remediation operations associated with repairing the computing component to correct a parameter value.

Once trained initially, a diagnostic machine learning model may act on an input 902 that may be one or more structured component logs, and the output 906 may be a label or other indication of one or more anomalous portions within the structured component logs. For a repair machine learning model, the input 902 may be one or more anomalous portions of structured component logs, and the repair machine learning model may output one or more remediation operations that identify what actions to take to repair the issue affecting the physical machine.

The training data may be updated based on, for example, feedback 908 on the accuracy of the current machine learning model 904. Updated training data 912 is fed back into the machine learning algorithm that, in turn, updates the machine learning model 904. Training data may also be updated whenever a new computing component type or version is added to the possible computing components that can make up a physical machine.

A machine learning model 904 is trained such that the model best fits the datasets of training data to the labels or outputs of the training data. Additionally, or alternatively, machine learning model 904 is trained such that when the model is applied to the datasets of the training data, a maximum number of results determined by the model matches the labels or outputs of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 8. PRACTICAL APPLICATIONS, ADVANTAGES, AND IMPROVEMENTS

One or more embodiments provide an efficient and scalable process for rapidly and automatically triaging a provisioned physical machine on a component-by-component basis. A stateless triaging process that tests components independently of the potential cause can ensure that the actual component causing the issue is not overlooked. The triaging process can also protect the customer's existing data and metadata during the triage process by disabling access to the data storage media. Using and updating machine learning models to identify the cause(s) of an issue and provide the steps to address the issue allows the process to learn about new components and new combinations of components as well as how to repair issues that arise in the new components.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause the one or more hardware processors to perform operations comprising:
identifying a provisioned physical machine for diagnosing an issue, the provisioned physical machine comprising a plurality of components;
executing respective tests on the components in a subset of components of the plurality of components, to generate a target component log, wherein the subset of components comprises one or more components;
obtaining a set of base component logs generated by execution of the respective tests on the subset of components of a set of base physical machines, wherein the set of base physical machines comprises one or more physical machines;
evaluating the target component log based on the set of base component logs to identify an anomalous portion of the target component log;
selecting a remediation operation based on the anomalous portion of the target component log; and
executing the remediation operation for the provisioned physical machine for addressing the issue.

2. The one or more non-transitory computer readable media of claim 1, wherein evaluating the target component log based on the set of base component logs comprises comparing a set of data characteristics of events in the target component log to an expected set of data characteristics that are determined based on the set of base component logs.

3. The one or more non-transitory computer readable media of claim 1, wherein identifying the anomalous portion of the target component log comprises:
determining that a detected sequence of events in the target component log does not match an expected sequence of events that is determined based on the set of base component logs.

4. The one or more non-transitory computer readable media of claim 1, wherein identifying the anomalous portion of the target component log comprises:
determining that an expected time between a pair of events in the target component log does not match an expected time between the pair of events that is determined based on the set of base component logs.

5. The one or more non-transitory computer readable media of claim 1, wherein identifying the anomalous portion of the target component log comprises, for a test:
determining that a set of components identified in the target component log as being accessed during the test does not match an expected set of components that would have been accessed during the test as determined based on the set of base component logs.

6. The one or more non-transitory computer readable media of claim 1, wherein identifying the anomalous portion of the target component log comprises:
determining that version or configuration data identified in the target component log does not match expected version or configuration data determined based on the set of base component logs.

7. The one or more non-transitory computer readable media of claim 1, wherein the operations further comprise: generating expected log data or expected log data characteristics, based on the set of base component logs, for executing the evaluating operation.

8. The one or more non-transitory computer readable media of claim 7, wherein generating expected log data or expected log data characteristics comprises training a machine learning model to generate the expected log data or expected log data based on the set of base component logs.

9. The one or more non-transitory computer readable media of claim 1, wherein the target component log and base component logs are structured logs in accordance with a definition.

10. The one or more non-transitory computer readable media of claim 1, wherein the operations further comprise: prior to executing the respective tests, disabling a connection to a storage component comprised in the provisioned physical machine.

11. The one or more non-transitory computer readable media of claim 1, wherein the operations further comprise: identifying the subset of components on which to execute the respective tests using a mapping between the issue and one or more components of the plurality of components.

12. The one or more non-transitory computer readable media of claim 1, wherein a first test is executed on a first component in the subset of components and a second test is executed on a second component in the subset of components, wherein the first test is different from the second test.

13. The one or more non-transitory computer readable media of claim 1, wherein the operations further comprise:
identifying the individual components in the plurality of component for the provisioned physical machine; and
identifying one or more tests corresponding to the respective individual components.

14. A method comprising:
identifying a provisioned physical machine for diagnosing an issue, the provisioned physical machine comprising a plurality of components;
executing respective tests on the components in a subset of components of the plurality of components, to generate a target component log, wherein the subset of components comprises one or more components;
obtaining a set of base component logs generated by execution of the respective tests on the subset of components of a set of base physical machines, wherein the set of base physical machines comprises one or more physical machines;
evaluating the target component log based on the set of base component logs to identify an anomalous portion of the target component log;
selecting a remediation operation based on the anomalous portion of the target component log;
executing the remediation operation for the provisioned physical machine for addressing the issue; and
wherein the method is performed by at least one device including a hardware processor.

15. The method of claim 14, wherein evaluating the target component log based on the set of base component logs comprises comparing a set of data characteristics of events in the target component log to an expected set of data characteristics that are determined based on the set of base component logs.

16. The method of claim 14, wherein identifying the anomalous portion of the target component log comprises:
determining that a detected sequence of events in the target component log does not match an expected sequence of events that is determined based on the set of base component logs.

17. The method of claim 14, wherein identifying the anomalous portion of the target component log comprises at least one of:
determining that an expected time between a pair of events in the target component log does not match an expected time between the pair of events that is determined based on the set of base component logs; and
determining that version or configuration data identified in the target component log does not match expected version or configuration data determined based on the set of base component logs.

18. The method of claim 14, wherein identifying the anomalous portion of the target component log comprises, for a test:
determining that a set of components identified in the target component log as being accessed during the test does not match an expected set of components that would have been accessed during the test as determined based on the set of base component logs.

19. The method of claim 14, further comprising:
generating expected log data or expected log data characteristics, based on the set of base component logs, for executing the evaluating operation.

20. The method of claim 19, wherein generating expected log data or expected log data characteristics comprises training a machine learning model to generate the expected log data or expected log data based on the set of base component logs.

21. A system comprising:
at least one device including a hardware processor;
the system being configured to perform operations comprising:
identifying a provisioned physical machine for diagnosing an issue, the provisioned physical machine comprising a plurality of components;
executing respective tests on the components in a subset of components of the plurality of components, to generate a target component log, wherein the subset of components comprises one or more components;
obtaining a set of base component logs generated by execution of the respective tests on the subset of components of a set of base physical machines, wherein the set of base physical machines comprises one or more physical machines;
evaluating the target component log based on the set of base component logs to identify an anomalous portion of the target component log;
selecting a remediation operation based on the anomalous portion of the target component log; and
executing the remediation operation for the provisioned physical machine for addressing the issue.

22. The system of claim 21, wherein evaluating the target component log based on the set of base component logs comprises comparing a set of data characteristics of events in the target component log to an expected set of data characteristics that are determined based on the set of base component logs.
